(19) United States
(12) Patent Application Publication
(10) Pub. No.: US 2012/0169576 A1
(43) Pub. Date: Jul. 5, 2012

(54) DISPLAY PANEL

(75) Inventors: Wen-Chun Wang, Taichung City (TW); Ming-Chang Yu, Taichung City (TW); Wan-Jen Tsai, Taichung City (TW); Min-Shian Tsai, Taichung City (TW); Hsi-Rong Han, Taichung City (TW)

(73) Assignees: WINTEK CORPORATION, Taichung City (TW); WINTEK (CHINA) TECHNOLOGY LTD., Guangdong Province (CN)

(21) Appl. No.: 13/335,977

(22) Filed: Dec. 23, 2011

(30) Foreign Application Priority Data
Dec. 31, 2010 (TW) 99147222

(51) Int. Cl. G09G 3/36

(52) U.S. Cl. 345/88; 345/87

(57) ABSTRACT

A display panel including a first substrate, a second substrate, a liquid crystal layer, a pixel structure array, a common electrode layer, and spacers is provided. The liquid crystal layer is disposed between the first substrate and the second substrate opposite thereto. The pixel structure array disposed on the first substrate is located between the liquid crystal layer and the first substrate and includes scan lines, data lines, active devices, and pixel electrodes. Each active device is connected to one scan line and one data line intersected therewith. Each pixel electrode crosses over one data line and one active device and is electrically connected to the corresponding one active device. The common electrode layer is disposed on the second substrate. The spacers disposed between the first substrate and the second substrate are located above the scan lines. The spacers are respectively located at centers of the pixel electrodes.

### CROSS-REFERENCE TO RELATED APPLICATION

This application claims the priority benefit of Taiwan application serial no. 99147222, filed on Dec. 31, 2010. The entirety of the above-mentioned patent application is hereby incorporated by reference herein and made a part of this specification.

### BACKGROUND OF THE APPLICATION

1. Field of the Invention

The invention generally relates to a display panel, and more particularly, to a display panel having wide viewing angle characteristic.

2. Description of Related Art

To have a better display quality, the liquid crystal displays with high contrast ratio, no gray scale inversion, little color shift, high luminance, full color, high responsive speed, and wide viewing angle are the development trend. From the aspect of the wide viewing angle technology, the common displays include In-Plane Switching (IPS) LCD, Twisted Nematic (TN) LCD, fringe field switching (FFS) LCD, multi-domain vertical alignment (MVA) LCD, and the like.

An MVA LCD panel can have wide viewing angle effect by the disposition of alignment protrusions. FIG. 8 is a top view schematically illustrating a conventional MVA LCD panel. With reference to FIG. 8, an MVA LCD panel 10 includes a plurality of scan lines 12 (one is shown exemplarily), a plurality of data lines 14, a plurality of active devices 16, a plurality of pixel electrodes 18, and a plurality of alignment protrusions 20. The scan lines 12 are intersected the data lines 14 and each of the active devices 16 is electrically connected to one scan line 12 and one data line 14. Furthermore, each pixel electrode 18 is electrically connected to the scan line 12 and the data line 14 through the corresponding active device 16. The alignment protrusions 20 are disposed over the pixel electrodes 18.

If an MVA LCD panel 10 is pressed, the liquid crystal molecules may be disordered tilted. Under the configuration of the alignment protrusions 20, the disordered arranged liquid crystal molecules of the MVA LCD panel 10 though can be rearranged in an order arrangement; the time required for the rearrangement is still unsatisfactory. It is to say that the restoring efficiency of the liquid crystal molecules is not favorable. Furthermore, the disposition location of the alignment protrusions 20 can not have the image display function, which reduces the display aperture ratio of the MVA LCD panel 10. However, the display aperture ratio is demanded more stringent with the enhanced resolution of the MVA LCD panel 10. Accordingly, there is still room for further improvement of the display quality of the MVA LCD panel 10.

### SUMMARY OF THE INVENTION

The invention directs to a display panel with a high aperture ratio and desirable liquid crystal restoring efficiency.

An embodiment of the invention provides a display panel including a first substrate, a second substrate, a liquid crystal layer, a pixel structure array, a common electrode layer, and a plurality of spacers. The second substrate is opposite to the first substrate. The liquid crystal layer is disposed between the first substrate and the second substrate. The pixel structure array is disposed on the first substrate and located between the first substrate and the liquid crystal layer. The pixel structure array includes a plurality of scan lines, a plurality of data lines, a plurality of active devices, and a plurality of pixel electrodes. The data lines intersect the scan lines. Each of the active devices is electrically connected to one of the scan lines and one of the data lines, respectively. Each of the pixel electrodes is across over one of the scan lines and one of the active devices and electrically connected to the one of the active devices. The common electrode layer is disposed on the second substrate and located between the second substrate and the liquid crystal layer. The spacers are disposed between the first substrate and the second substrate, located above the scan lines, and the spacers are respectively located at centers of the pixel electrodes.

In light of the foregoing, the scan line and the spacer are disposed in the center of the pixel electrode according to the invention. The locations where the scan lines and the spacers are located do not perform the display function and thus the overlapping of the scan lines and the spacers facilitates improve the display aperture ratio of the display panel. In addition, the spacers respectively located in the centers of the pixel electrodes provide the alignment function, which facilitates the wide viewing angle display characteristic of the display panel. Specifically, the spacers located in the centers of the pixel electrodes are conducive to enhance the liquid crystal restoring efficiency.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic top view of a display panel according to an embodiment of the invention.

FIG. 2 is a schematic cross-sectional view of the display panel along line I-I′ depicted in FIG. 1.

FIG. 3 is a schematic cross-sectional view of the display panel along the scan line depicted in FIG. 1.

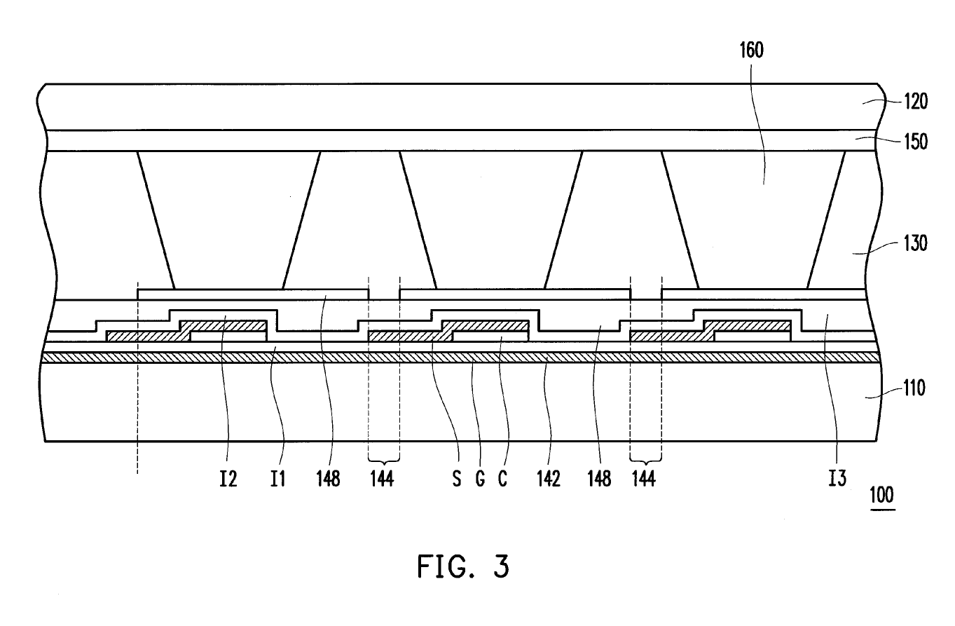

FIG. 4A illustrates a schematic cross-sectional view of a display panel according to another embodiment of the invention.

FIG. 4B illustrates a top view of the color filter layer of the display panel depicted in FIG. 4A.

FIG. 5 schematically illustrates a top view of the pixel structure array of the display panel depicted in FIG. 1 according to another embodiment.

FIG. 6 schematically shows a top view of the storage capacitance electrode depicted in FIG. 5.

FIG. 7 is partial cross-sectional view of the pixel structure array along the line A-A′ depicted in FIG. 5.

FIG. 8 is a top view schematically illustrating a conventional MVA LCD panel.

### DESCRIPTION OF EMBODIMENTS

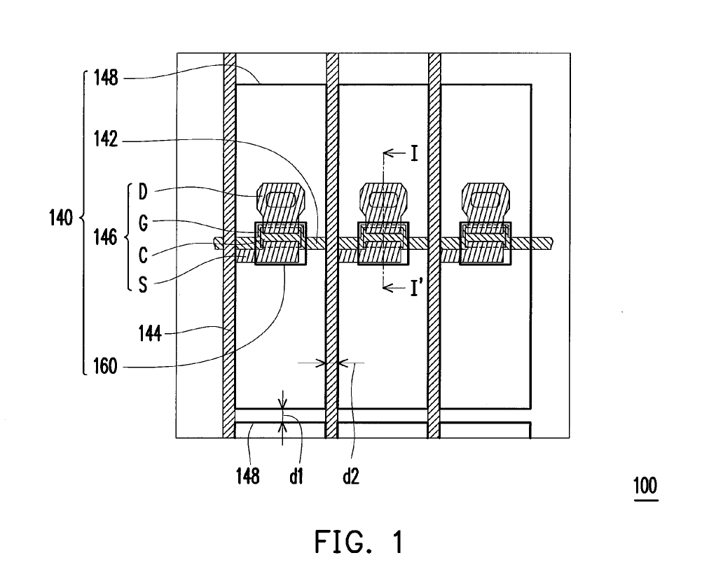

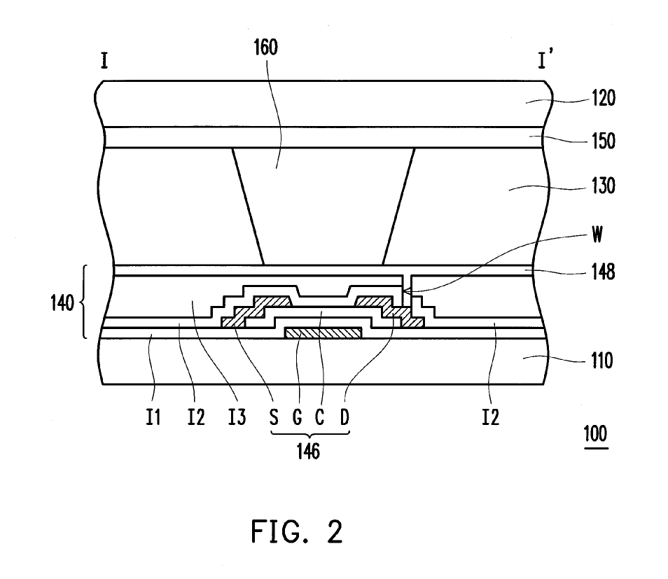

FIG. 1 illustrates a schematic top view of a display panel according to an embodiment of the invention and FIG. 2 is a schematic cross-sectional view of the display panel along line I-I′ depicted in FIG. 1. With reference to FIG. 1 and FIG. 2 together, a display panel 100 includes a first substrate 110, a second substrate 120, a liquid crystal layer 130, a pixel structure array 140, a common electrode layer 150, and a plurality of spacers 160. The second substrate 120 is opposite to the first substrate 110. The liquid crystal layer 130 is disposed between the first substrate 110 and the second substrate 120. The pixel structure array 140 is disposed on the first substrate 110 and located between the first substrate 110 and the liquid crystal layer 130. The common electrode layer 150 is disposed on the second substrate 120 and located between the second substrate 120 and the liquid crystal layer 130. The spacers 160 are disposed between the first substrate 110 and the second substrate 120. In the present embodiment, the spacers 160 is leant against the first substrate 110 and the second substrate 120 so that a proper cell gap is maintained in the display panel 100.

The pixel structure array 140 includes a plurality of scan lines 142 (only one is shown for a clear illustration), a plurality of data lines 144, a plurality of active devices 146, and a plurality of pixel electrodes 148. The data lines 144 intersect the scan lines 142. Each of the active devices 146 is electrically connected to one of the scan lines 142 and one of the data lines 144, respectively. Each of the pixel electrodes 148 is across over one of the scan lines 142 and one of the active devices 146 and electrically connected to the one of the active devices 146, i.e. the corresponding active device 146.

Each of the active devices 146 has a gate G, a source S, and a drain D. The channel layer C is located above the gate G. The source S and the drain D contact the channel layer C and located at two sides of the gate G. In addition, the pixel structure array 140 further has insulation layers I1 and I2 and an overcoat layer I3. The insulation layer I1 covers the gate G and the insulation layer I2 covers the source S and the drain D while the overcoat layer I3 is located between the pixel electrode 148 and the insulation layer I2. A contact opening W is configured in the overcoat layer I3 and the insulation layer I2 so as to electrically connect the pixel electrode 148 to the drain D through the contact opening W. The configuration of the overcoat layer I3 conduces to mitigate the electric coupling effect between the pixel electrode 148 and the data line 146 so that edges of the pixel electrode 148 can overlap the adjacent data lines 144. The electric coupling effect between another scan line 142 and the pixel electrode 148 can also be reduced because of the configuration of the overcoat layer I3. In this embodiment, a rubbing alignment layer, a photo-alignment layer, or a polymer stabilized alignment (PSA) layer consisted of an alignment material layer and a polymer layer can be selectively disposed on a side of the pixel electrode 148 away from the overcoat layer I3. Namely, the alignment of the liquid crystal layer 130 of the present embodiment can be achieved by using a rubbing alignment method, a photo alignment method, a polymer stabilized alignment method, or the like.

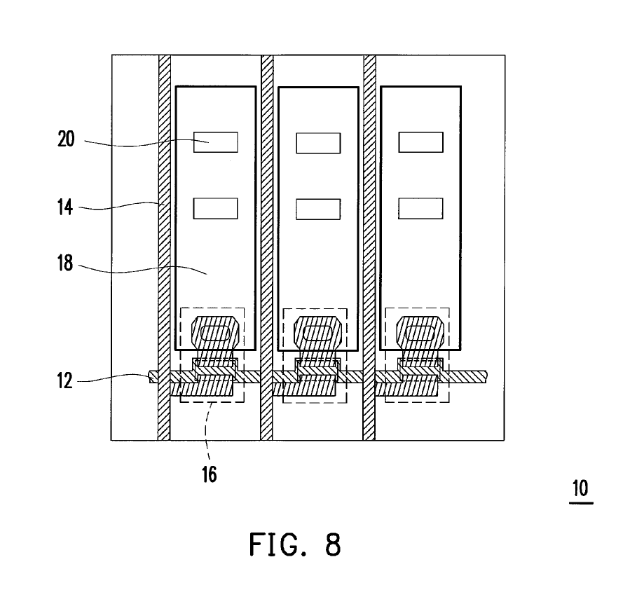

With the improvement of the resolution of the display panel 100, the disposition area of the pixel electrode 148 is reduced, for example, the size of the pixel can be reduced to 280 ppi. Herein, the light transmission rate of the display panel 100 has significant influence on the display quality. If conventional alignment protrusions (as the alignment protrusions 20 shown in FIG. 8) are used for achieving the alignment of the liquid crystal molecules, the light transmission area is seriously restricted because the locations of the alignment protrusions can not perform the display function. In the present embodiment, the improvement lies in that the pixel electrode 148 is across over the scan line 142 and the pixel electrode 148 is, for example, divided into two regions by the scan line 142. Furthermore, the areas of the two regions of the pixel electrode 148 divided by the scan line 142 are substantially identical to each other. The spacers 160 are located above the scan lines 142 and are respectively configured at the centers of the pixel electrodes 148. Accordingly, the spacers 160 have the alignment function to render the liquid crystal molecules of the liquid crystal layer 130 incline from the periphery of the pixel electrode 148 toward the center of the pixel electrode 148 during a displaying period. As such, the display panel 100 of the present invention achieves desirable wide viewing angle display effect.

When the display panel 100 is pressed by en external force, the liquid crystal molecules of the liquid crystal layer 130 are disorder arranged. As a result, the images displayed by the display panel 100 are adversely affected. Once the liquid crystal molecules of the liquid crystal layer 130 are not restored in the original arrangement, the display quality of the display panel 100 becomes unsatisfactory. Therefore, the display panel 100 is demanded to have the characteristic of rapid liquid crystal restoring efficiency. The demand of rapid liquid crystal restoring efficiency is further stringent when the display panel 100 is applied in a touch display apparatus. In this embodiment, a height of the spacer 160 is, for example, substantially equivalent to the cell gap of the liquid crystal layer 130, e.g. 3 μm to 4 μm. The disposition of the spacer 160 is conducive to the enhancement of the liquid crystal restoring efficiency of the liquid crystal layer 130 in the display panel 100. That is, the liquid crystal molecules of the liquid crystal layer 130 can be rapidly rearranged in the original arrangement after the display panel 100 is pressed because of the disposition of the spacers 160, which can improve the display quality of the display panel 100.

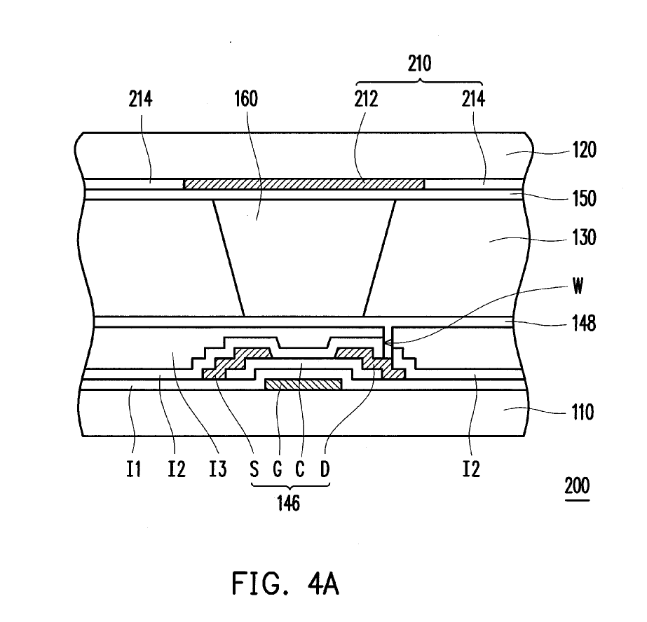

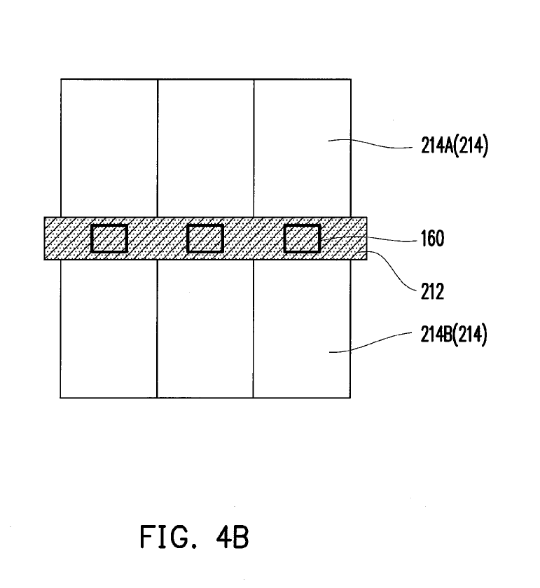

FIG. 4A illustrates a schematic cross-sectional view of a display panel according to an embodiment of the invention and FIG. 4B illustrates a top view of the color filter layer of the display panel depicted in FIG. 4A. With reference to FIG. 4A, the display panel 200 is substantially similar to the display panel 100 described in the foregoing embodiment, and the difference therebetween lies in that the display panel 200 further includes a color filter layer 210 in addition to all the components of the display panel 100. It is noted that a top view of the pixel structure array in display panel 200 can be referred to the drawing illustrated in FIG. 1. In detail, the color filter layer 210 is disposed on the second substrate 120 and located between the common electrode layer 150 and the second substrate 120.

With reference to FIG. 4A and FIG. 4B together, the color filter layer 210 includes a black matrix 212 and a plurality of color filter patterns 214. The black matrix 212 is configured corresponding to the scan lines 142 depicted in FIG. 1, and each color filter pattern 214 includes a first portion 214A and a second portion 214B. The first portion 214A and the second portion 214B are respectively located at two sides of the black matrix 212. The spacers 160 are disposed between the black matrix 212 and the scan lines 142. The pixel electrode 140 according to the embodiment is configured across over the scan line 142, wherein the region where each pixel electrode 148 is located is served as a sub-pixel for displaying a same color image. Accordingly, the first portion 214A and the second portion 214B of each color filter pattern 214 in the color filter layer 210 are the color filter patterns having the same color. For example, the first portion 214A and the second portion 214B depicted in FIG. 4B can both be red color filter patterns, green color filter patterns, or blue color filter patterns.

It is noted that the locations where the active device 146, the spacers 160, and the scan lines 142 are located are the locations having poor display quality. Therefore, the black matrix 212 configured corresponding to the locations having poor display quality facilitates to provide a shading function and thus improve the display quality of the display panel 200. Alternatively, the color filter layer 210 may be combined with the pixel structure array 140 to form a color-filter-on-array (COA) structure or an array-on-color-filter (AOC) structure.

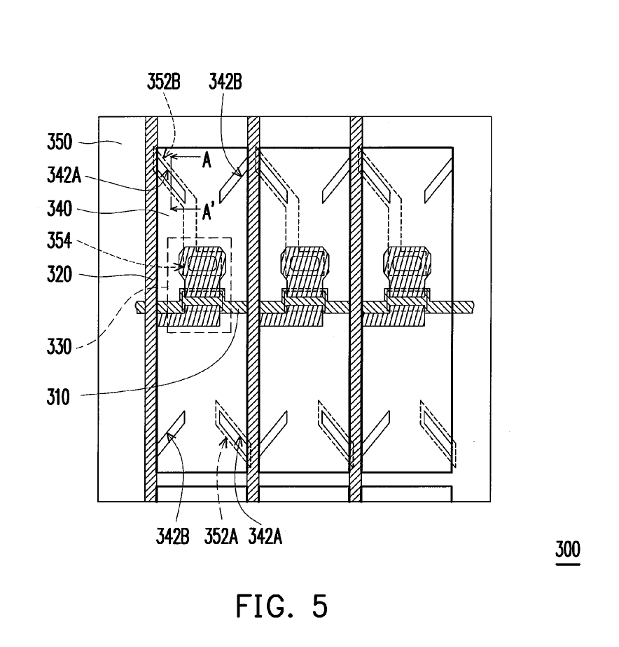

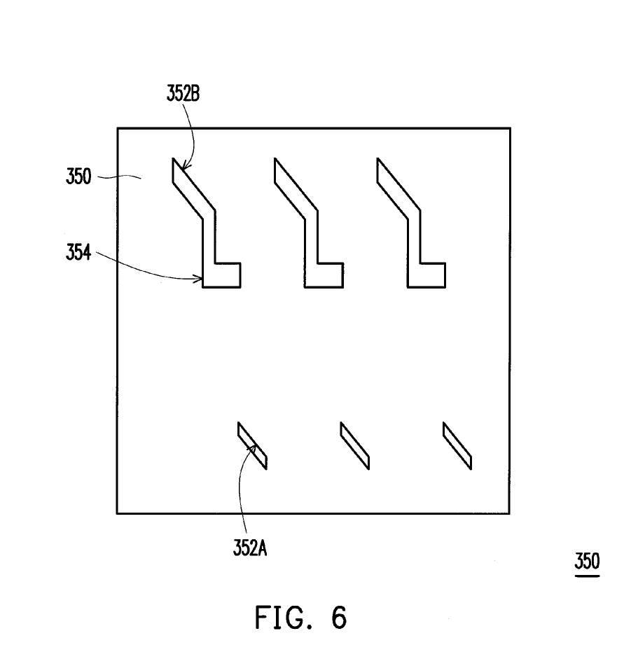

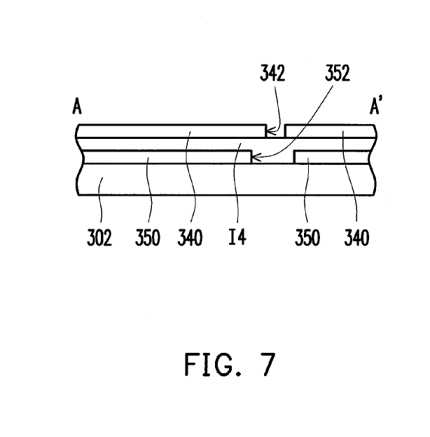

FIG. 5 schematically illustrates a top view of the pixel structure array of the display panel depicted in FIG. 1 according to another embodiment. FIG. 6 schematically shows a top view of the storage capacitance electrode depicted in FIG. 5. FIG. 7 is partial cross-sectional view of the pixel structure array along the line A-A′ depicted in FIG. 5. With reference to FIG. 5, FIG. 6, and FIG. 7 simultaneously, the pixel structure array 300 includes a plurality of scan lines 310 (only one is shown for clear illustration), a plurality of data lines 320, a plurality of active devices 330, a plurality of pixel electrodes 340, and a storage capacitance electrode 350. The data lines 320 intersect the scan lines 310. Each of the active devices 330 is electrically connected to one of the scan lines 310 and one of the data lines 320, respectively. Each of the pixel electrodes 340 is across over one of the scan lines 310 and one of the active devices 330 and electrically connected to the one of the active devices 330, i.e. the corresponding active device 146.

In addition, the storage capacitance electrode 350 can be disposed under the pixel electrode 340. Based on the drawings of FIG. 5 and FIG. 7, the pixel structure array 300 is disposed on the substrate 302. The storage capacitance electrode 350 is located between the pixel electrode 340 and the substrate 302 and at least one insulation layer I4 is disposed between the storage capacitance electrode 350 and the pixel electrode 340. The pixel structure array 300 depicted in FIGS. 5˜7 and the related components are capable of being applied in the display panel 100 depicted in FIG. 1 to substitute the pixel structure array 140, wherein the insulation layer I4 in FIG. 7 can be served as the film layer of the insulation layer I1 or I2 illustrated in FIG. 2.

In the present embodiment, each pixel electrode 340 exemplarily has at least one slit, e.g. 342A and 342B and the first slit 342B exposes a portion of the storage capacitance electrode 350. The storage capacitance electrode 350 has at least one second slit, e.g. 352A and 352B. Herein, the second slits 352A and 352B are located directly under the first slit 342A. In addition, the second slit 352B further communicates with the contact opening 354 exposing the active device 350, such that the pixel electrode 340 can be electrically connected to the active device 330 through the contact opening 354.

The first slits 342A and 342B are extended from the edges of the pixel electrode 340 towards the location where the corresponding spacer 160 is located, i.e. the center of the pixel electrode 340 when the pixel structure array 300 is applied in the display panel 100 depicted in FIG. 1. The storage capacitance electrode 350 is not disposed right under the first slit 432A. Accordingly, the configuration of the first slit 342A facilitates to form a driving electric field to drive the liquid crystal molecules of the liquid crystal layer 130 when the display panel 100 displays images, which improves the display brightness of the display panel 100. It is worthy noted that the number of the second slits 352A and 352B can be increased or reduced according to the required capacitance in the pixel structure array 300. In other embodiments, the storage capacitance electrode 350 may not have the second slits 352A and 352B, but merely have the contact opening 354.

In view of the above, the pixel electrode in the invention is configured across over the scan line and the center of each pixel electrode is disposed with a spacer. As such, the display panel of the present invention can have desirable wide viewing angle display effect. In the extending direction of the data line, a distance between two adjacent pixel electrodes can be smaller than the line width of the scan line, which enhances the display aperture ratio of the display panel. The edges of the pixel electrodes can be overlapped the data line so as to enhance the display aperture ratio of the display panel. In addition, the spacers configured in the canters of the pixel electrodes can provide the alignment function and conduce to improve the liquid crystal restoring efficiency. Therefore, abnormal display of the display panel due to the pressing of the external force is not liable to occur according to the invention. As a whole, the display panel according to the invention has desirable display effect and stable display quality.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. a display panel, comprising:
a first substrate;
a second substrate opposite to the first substrate;
a liquid crystal layer disposed between the first substrate and the second substrate;
a pixel structure array disposed between the first substrate and the liquid crystal layer and comprising:
a plurality of scan lines;
a plurality of data lines intersecting the scan lines;
a plurality of active devices, each of the active devices being electrically connected to one of the scan lines and one of the data lines;
a plurality of pixel electrodes, each of the pixel electrodes being across over one of the scan lines and one of the active devices and electrically connected to the one of the active devices;
a common electrode layer disposed on the second substrate; and
a plurality of spacers disposed between the first substrate and the second substrate, located above the scan lines, and the spacers being respectively located at centers of the pixel electrodes.

2. The display panel as claimed in claim 1, wherein each of the pixel electrodes is divided into two regions by the one of the scan lines and the two regions have identical areas.

3. The display panel as claimed in claim 1, wherein edges of each of the pixel electrodes are substantially overlapped adjacent data lines.

4. The display panel as claimed in claim 1, further comprising a color filter layer disposed on the second substrate and located between the common electrode layer and the second substrate.

5. The display panel as claimed in claim 4, wherein the color filter layer comprises a black matrix and a plurality of color filter patterns, the black matrix is configured corresponding to the scan lines, and each of the color filter patterns comprises a first portion and a second portion respectively disposed at two opposite sides of the black matrix.

6. The display panel as claimed in claim 5, wherein the spacers are disposed between the black matrix and the scan lines.

7. The display panel as claimed in claim 5, wherein a color of the first portion is identical to a color of the second portion.

8. The display panel as claimed in claim 1, further comprising a storage capacitance electrode disposed between the pixel electrodes and the first substrate.

9. The display panel as claimed in claim 8, wherein each of the pixel electrodes has at least one first slit, the first slit is extended from a periphery of the pixel electrode towards a location of one corresponding spacer, and the first slit exposes a portion of the storage capacitance electrode.

10. The display panel as claimed in claim 9, wherein the storage capacitance electrode has a second slit located directly under the first slit.
